(19) United States
(12) Patent Application Publication
(10) Pub. No.: US 2023/0027193 A1
(43) Pub. Date: Jan. 26, 2023

(54) BATTERY PACK

(71) Applicant: MILWAUKEE ELECTRIC TOOL CORPORATION, Brookfield, WI (US)

(72) Inventors: Cameron R. Schulz, Milwaukee, WI (US); Samuel Sheeks, Germantown, WI (US); Matthew R. Polakowski, Greenfield, WI (US); Kyle C. Fassbender, Brookfield, WI (US)

(21) Appl. No.: 17/813,519

(22) Filed: Jul. 19, 2022

Related U.S. Application Data
(60) Provisional application No. 63/223,730, filed on Jul. 20, 2021.

(51) Int. Cl. H01M 50/583; H01M 50/296; H01M 50/213; H01M 50/218

(52) U.S. Cl. CPC H01M 50/583; H01M 50/296; H01M 50/213; H01M 50/218

(57) ABSTRACT

A battery pack includes a battery pack housing, a plurality of battery pack terminals, and a plurality of battery cells supported within the battery pack housing. At least one battery cell includes a battery cell terminal. The battery pack also includes a compound fuse electrically coupled between the battery cell terminal of the at least one battery cell and at least one battery pack terminal. The compound fuse comprises a first material and a second material that has a lower melting point than the first material. The compound fuse includes a first portion electrically coupled to the battery cell terminal, a second portion electrically coupled to the at least one battery pack terminal, and a fuse portion that connects the first portion to the second portion. The fuse portion is configured to establish a discontinuity between the first portion and the second portion during a hard short event.

### CROSS-REFERENCE TO RELATED APPLICATIONS

This application claims priority to co-pending U.S. Provisional Patent Application No. 63/223,730, filed Jul. 20, 2021, the entire content of which is hereby incorporated by reference.

### FIELD OF THE DISCLOSURE

The disclosure relates to battery packs, and more specifically, to battery packs for use with equipment or devices such as a power tool.

### BACKGROUND OF THE DISCLOSURE

In a battery pack, such as a power tool battery pack, protection may be provided by using a fuse in the current path of the battery pack.

### SUMMARY OF THE DISCLOSURE

The present disclosure provides, in one aspect, a battery pack including a battery pack housing, a plurality of battery pack terminals, and a plurality of battery cells supported within the battery pack housing and electrically connected to one another. At least one battery cell includes a battery cell terminal. The battery pack also includes a compound fuse electrically coupled between the battery cell terminal of the at least one battery cell and at least one battery pack terminal. The compound fuse comprises a first material and a second material that has a lower melting point than the first material. The compound fuse includes a first portion electrically coupled to the battery cell terminal, a second portion electrically coupled to the at least one battery pack terminal, and a fuse portion that connects the first portion to the second portion. The fuse portion is configured to establish a discontinuity between the first portion and the second portion during a hard short event.

In some constructions, the second material is clad in the first material on each of a first side and a second side. In some constructions, the second material is inlaid into the first material. In some constructions, the fuse portion is attached to the first portion and to the second portion by ultrasonic welding.

The present disclosure provides, in another aspect, a battery pack including a battery pack housing, a negative battery pack terminal and a positive battery pack terminal, and a plurality of battery cells supported within the battery pack housing and electrically connected to one another, to the negative battery pack terminal, and to the positive battery pack terminal. At least one battery cell includes a battery cell terminal. The battery pack also includes a compound fuse electrically coupled between the battery cell terminal and the negative battery pack terminal. The compound fuse comprises a first material and a second material that has a lower melting point than the first material. The compound fuse includes a first portion electrically coupled to the battery cell terminal, a second portion electrically coupled to at least one of the negative battery pack terminal and the positive battery pack terminal, and a fuse portion that connects the first portion to the second portion. The fuse portion is configured to establish a discontinuity between the first portion and the second portion during a hard short event. The fuse portion is formed from the second material

The present disclosure provides, in another aspect, a compound fuse for a battery pack. The compound fuse is configured to be coupled between a battery cell terminal of the battery pack and a battery pack terminal of the battery pack. The compound fuse includes a first portion located at a first end of the compound fuse, a second portion located at a second end of the compound fuse, and a fuse portion that connects the first portion to the second portion. The fuse portion is configured to establish a discontinuity between the first portion and the second portion during a hard short event. Each of the first portion, the second portion, and the fuse portion are at least partially formed of a first material. The first portion and the second portion are also partially formed of a second material that has a lower melting point than the first material.

Other aspects of the disclosure will become apparent by consideration of the detailed description and accompanying drawings.

### BRIEF DESCRIPTION OF THE DRAWINGS

FIG. 1 is a perspective view of a battery pack.

FIG. 2 is a perspective view of the battery pack of FIG. 1 having portions removed.

FIG. 3 is a detailed perspective view of the battery pack of FIG. 1 having portions removed and illustrating a fuse of the battery pack.

FIGS. 4 and 5A illustrate a fuse of the battery pack of FIG. 1 according to another embodiment.

FIG. 5B illustrates a fuse of the battery pack of FIG. 1 according to another embodiment.

FIGS. 6 and 7A illustrate a fuse of the battery pack of FIG. 1 according to another embodiment.

FIG. 7B illustrates a fuse of the battery pack of FIG. 1 according to another embodiment.

FIGS. 8A and 8B illustrate a strip of material from which a fuse of the battery pack of FIG. 1 may be formed.

FIGS. 9A and 9B illustrate a strip of material from which a fuse of the battery pack of FIG. 1 may be formed according to another embodiment.

FIGS. 10A and 10B illustrate a strip of material from which a fuse of the battery pack of FIG. 1 may be formed according to another embodiment.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. cl DETAILED DESCRIPTION

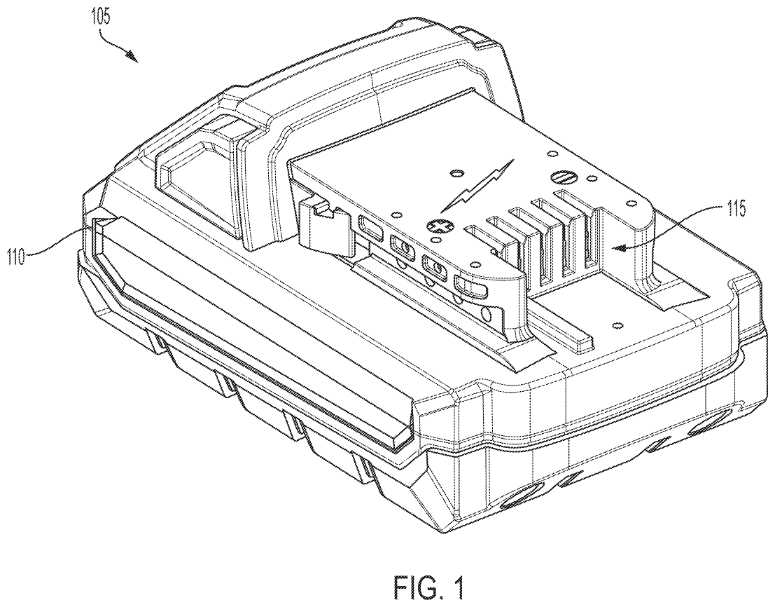

FIGS. 1-3 illustrate a battery pack 105 that may be used to provide power to electrical equipment or devices. Such electrical devices may include, e.g., a power tool (for example, a drill, a saw, a pipe cutter, an impact wrench, etc.), an outdoor tool (for example, a snow blower, a vegetation cutter, etc.), a lighting equipment, a power source, and the like.

As shown in FIG. 1, the battery pack 105 includes a battery pack housing 110 and battery pack terminals 115 protruding through openings formed in the housing. The battery pack terminals 115 mechanically and electrically couple to corresponding terminals (not shown) provided on the electrical device for transferring power from the battery pack 105 to the device. In some embodiments, the battery pack terminals 115 may include a power line, a ground line, and one more communication lines.

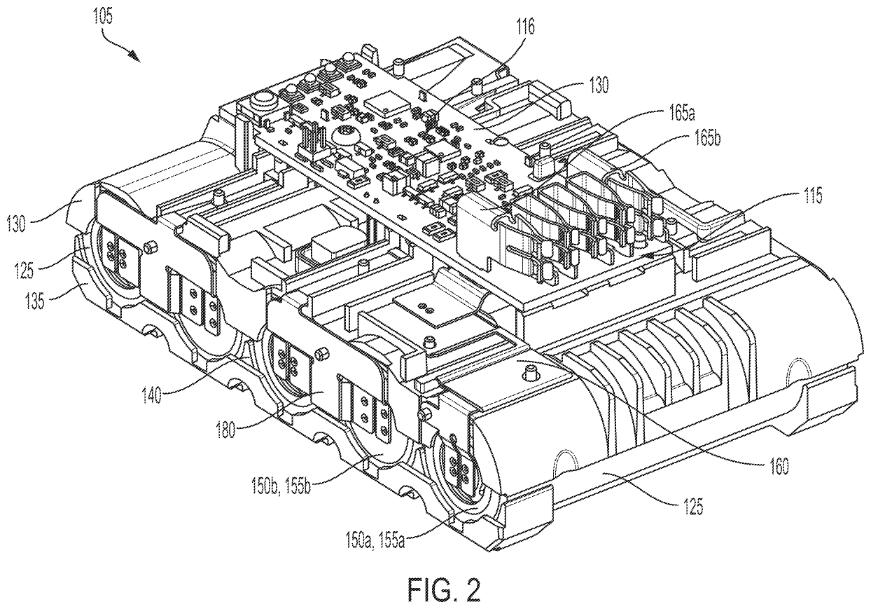

FIG. 2 illustrates the battery pack 105 with the housing 110 removed to expose internal components of the battery pack 105. As shown in FIG. 2, the battery pack 105 includes a printed circuit board (PCB) 120 that supports the battery pack terminals 115 and control circuitry 116 for controlling operation of the battery pack 105.

The illustrated battery pack 105 includes a plurality of cylindrical battery cells 125 that are electrically connected to provide a desired output (e.g., nominal voltage, current capacity, etc.) of the battery pack 105. In the illustrated construction, the battery pack 105 includes one string of five series-connected battery cells 125 (a “5S1P” battery pack). In other constructions (not shown), the battery pack 105 can include two strings of five series-connected battery cells (a “5S2P” pack), or three strings of five series-connected battery cells (a “5S3P” pack). In further constructions, the battery pack 105 may alternatively include fewer or more than five battery cells 125, and the battery cells 125 may be electrically coupled in other configurations. The illustrated battery pack 105 has a nominal output voltage of at least 18 V. The battery pack 105 is rechargeable, and the battery cells 125 may have a Lithium-based chemistry (e.g., Lithium, Lithium-ion, etc.) or any other suitable chemistry.

The battery pack 105 includes a top case 130 and a bottom case 135 that secure the battery cells 125 in the single row within the battery pack 105. Wedge elements 140 protrude from the respective cases 130, 135 to contact the battery cells 125 (for example, to hold the battery cells 125 in place). The cases 130, 135 substantially surround the circumferential side surfaces of the battery cells 125 but leave a first end face 150a and a second end face 150b of the battery cells 125 substantially exposed to allow the battery cells 125 to be electrically coupled in a circuit. Specifically, the first end face 150a defines a first terminal 155a (e.g., a positive terminal) of the battery cell 125 and the second end face 150b defines a second terminal 155b (e.g., a negative terminal) of the battery cell 125.

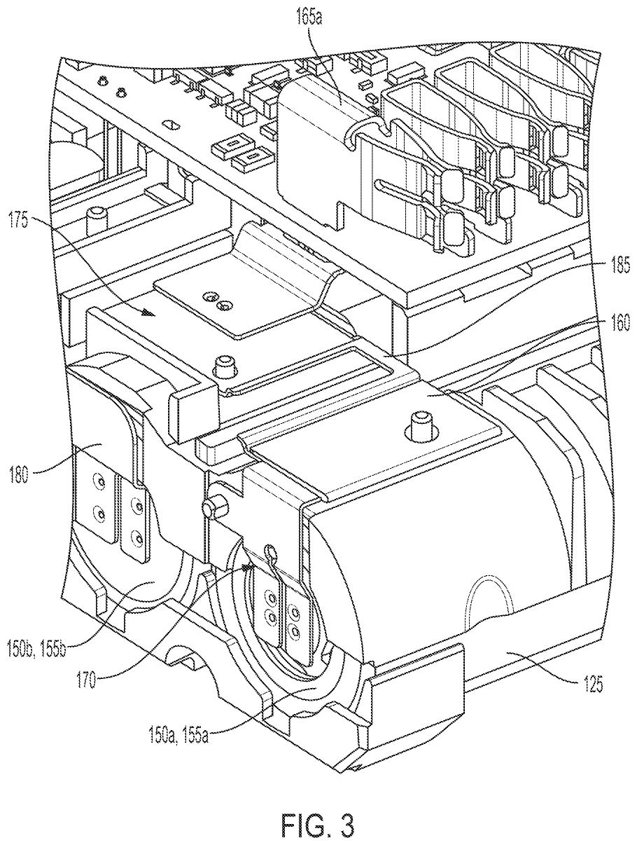

With reference to FIG. 3, a fuse 160 can be provided in a current path of the battery pack 105 to provide protection in case of, e.g., a hard short event or an overcharging event, i.e., when the current flowing through the battery pack circuit exceeds a predetermined limit. In the illustrated construction, the fuse 160 is coupled between the second terminal 155b of one of the battery cells 125 and a negative battery pack terminal 165a of the battery pack terminals 115. In other constructions, the fuse 160 may instead be provided between the first terminal 155a of the battery cell 125 and a positive battery pack terminal 165b of the battery pack terminals 115 (not shown). As shown, the fuse 160 includes a first end 170 directly attached to the second terminal 155b and a second end 175 coupled to the negative battery pack terminal 165a. In other embodiments (not shown), the first end 170 may alternatively connect to a bus bar 180 that electrically connects two or more terminals of the battery cells.

The fuse 160 includes a fusible portion 185 provided between the first end 170 and the second end 175. During a hard short of the fuse 160, the fusible portion 185 is configured to establish a discontinuity between the first end 170 and the second end 175 (e.g., due to melting), thereby disconnecting the first end 170 from the second end 175 and interrupting the current path of the battery pack 105.

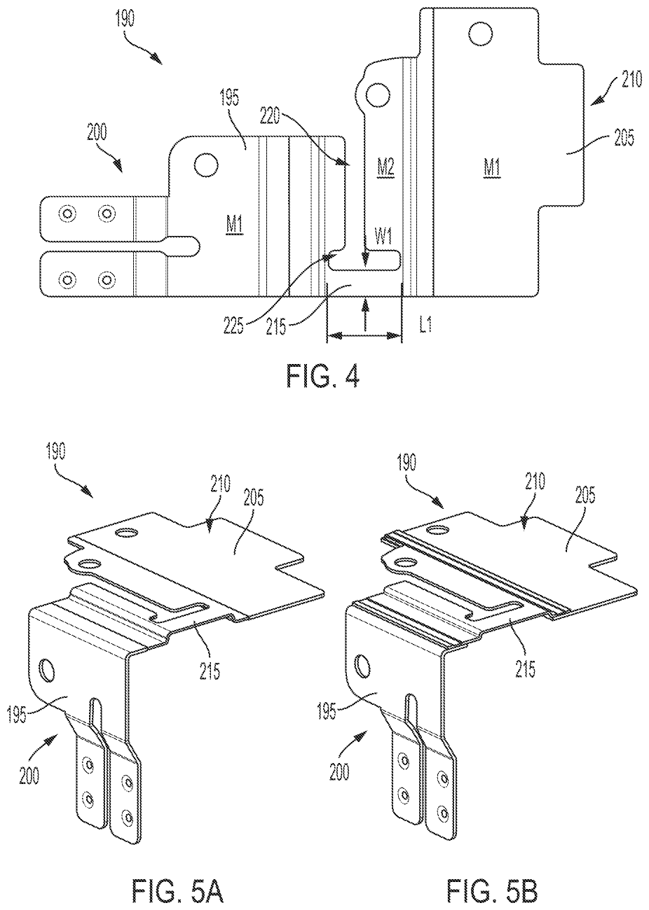

FIGS. 4-5B illustrate a compound fuse 190 formed from two different conductive materials M1, M2 (e.g., two different metals, metallic alloys, and the like). The compound fuse 190 can be utilized in the battery pack 105 in place of the fuse 160 described above. In the illustrated embodiment, the compound fuse 190 includes some portions made from the first material M1 (e.g., a copper-based material) and other portions made from the second material M2 (e.g., an aluminum-based material). Specifically, the compound fuse 190 includes a first portion 195 that defines a first end 200, a second portion 205 that defines a second end 210, and a fusible portion 215 extending between and connecting the first and second portions 195, 205. The first portion 195 and the second portion 205 are formed at least partially from the first material M1, while the fusible portion 215 is formed at least partially from the second material M2. In some embodiments, the fusible portion 215 is formed entirely from the second material M2. The second material M2 has a lower melting point than the first material M1. This allows the fusible portion 215 to release relatively less heat during a hard short event as compared to a traditional fuse in which the fusible portion is formed from the same material M1 as the first and second portions 195, 205. In addition, this can prevent the region of the housing 110 (FIG. 1) adjacent the compound fuse 190 from melting during a hard short event. Moreover, mica can traditionally be provided adjacent the fuse in battery packs as a heat shield to prevent the housing from melting during a hard short event. But, by implementing the compound fuse 190 having the fusible portion 215 formed from the second material M2, an amount of mica provided in the battery pack 105 can be reduced or eliminated.

With continued reference to FIG. 4, the compound fuse 190 can be formed as a generally flat member and subsequently bent into, e.g., an L-shape as shown in FIGS. 5A and 5B for implementation in the battery pack 105. In the illustrated embodiment, the fusible portion 215 is defined by a first slot 220 that extends across a portion of a width of the compound fuse 190 (i.e., along a direction transverse to a longitudinal extent of the compound fuse 190 as depicted in FIG. 4) to establish a width W1 of the fusible portion 215. The first slot 220 partially separates the first portion 195 from the second portion 205. The fusible portion 215 can be further defined by a second slot 225 that extends transverse to the first slot 220 (i.e., along a direction parallel to the longitudinal extent of the compound fuse 190 as depicted in FIG. 4) to establish a longitudinal length L1 of the fusible portion 215. The fusible portion 215 defines a minimum cross-sectional area of the compound fuse 190 along the current flow path through the compound fuse 190 to ensure that the compound fuse 190 melts in the fusible portion 215 to establish a discontinuity between the first portion 195 and the second portion 205 during a hard short event.

In an embodiment shown in FIG. 5A, the entire compound fuse 190, including the first and second portions 195, 205 and the fusible portion 215 can be formed from the second material M2 as a core material, and then a first material M1 can be coupled to the second material M2 in each of the first and second portions 195, 205. The first material M1 can be coupled to the second material M2 by, e.g., electroplating, or plasma coating.

In an embodiment shown in FIG. 5B, the first and second portions 195, 205 can be formed from the first material Ml, and then a central section that defines the fusible portion 215 can be attached to the first portion 195 and to the second portion 205 by ultrasonic welding.

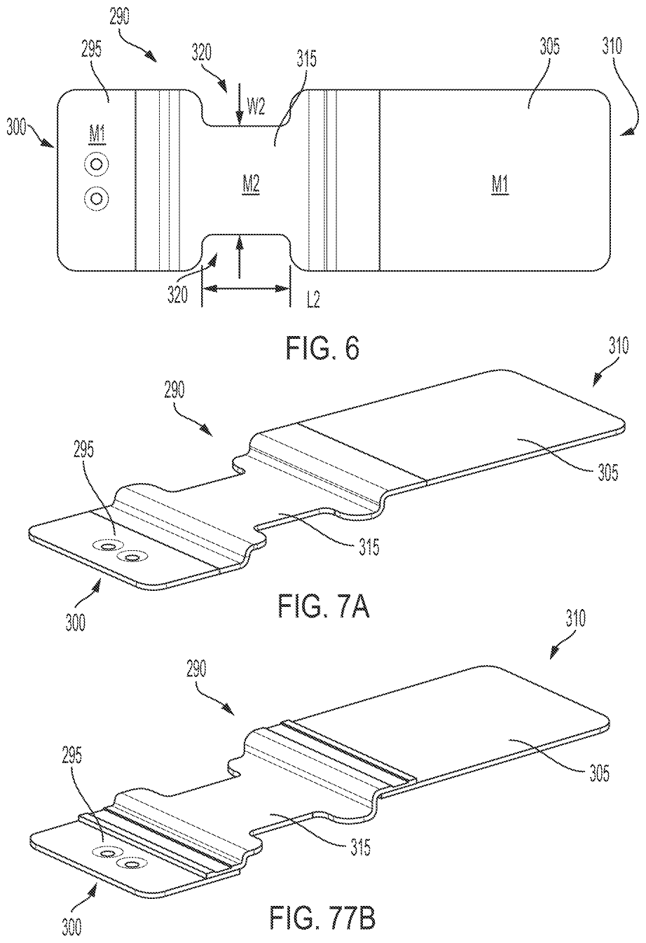

FIGS. 6-7B illustrate a compound fuse 290 according to another embodiment of the disclosure. The compound fuse 290 is similar to the compound fuse 190 described above in connection with FIGS. 4-5B. Features of the compound fuse 290 that are similar to features of the compound fuse 190 described above are assigned the same reference numerals “plus 100.”

The compound fuse 290 is also formed from the two different conductive materials M1, M2 and can be utilized in the battery pack 105 in place of the fuse 160 described above. In the illustrated embodiment, the compound fuse 290 includes a first portion 295 that defines the first end 300, a second portion 305 that defines the second end 310, and a fusible portion 315 extending between and connecting the first and second portions 295, 305. The compound fuse 290 is also formed as a generally flat member (FIG. 6) and subsequently bent to include bends or ridges in the region of the fusible portion 315 (FIGS. 7A, 7B). In the illustrated embodiment, the fusible portion 315 is defined by a pair of lateral slots 320 that each extend inward from each lateral side of the compound fuse 290 (i.e., along a direction transverse to a longitudinal extent of the compound fuse 290 as depicted in FIG. 6) to establish a width W2 of the fusible portion 315 and a length L2 of the fusible portion 315. The fusible portion 315 defines a minimum cross-sectional area of the compound fuse 290 along the current flow path through the compound fuse 290 to ensure that the compound fuse 290 melts in the fusible portion 315 to establish a discontinuity between the first portion 295 and the second portion 305 during a hard short event. The cross-sectional area of the fusible portion 315 is larger than the cross-sectional area of the fusible portion 215 of the compound fuse 190 described above, such that the compound fuse 290 is rated for a higher current load than the compound fuse 190.

In an embodiment shown in FIG. 7A, the entire compound fuse 290, including the first and second portions 295, 305 and the fusible portion 315 can be formed from the second material M2 as a core material, and then a first material M1 can be coupled to the second material M2 in each of the first and second portions 295, 305. The first material M1 can be coupled to the second material M2 by, e.g., electroplating, or plasma coating.

In an embodiment shown in FIG. 7B, the first and second portions 295, 305 can be formed from the first material M1, and then a central section that defines the fusible portion 315 can be attached to the first portion 295 and to the second portion 305 by ultrasonic welding.

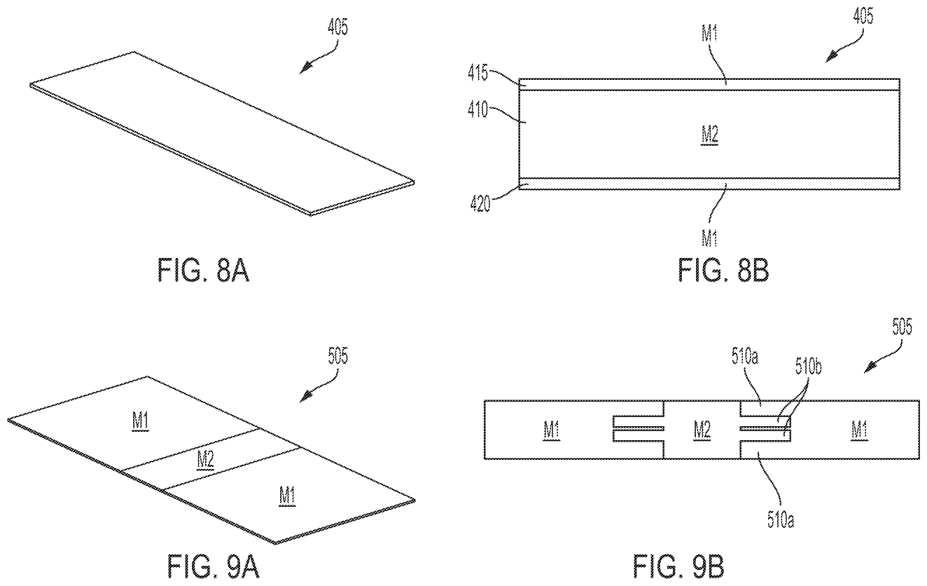

FIGS. 8A and 8B illustrate a material strip 405 from which the compound fuses 190, 290 can be formed. The material strip 405 is a clad metal material strip 405 provided as an overlay including the second material M2 (e.g., an aluminum-based material) clad in the first material M1 (e.g., copper-based material) on both sides. The material strip 405 includes an inner layer 410 formed from the second material M2, and first and second outer layers 415, 420 each formed from the first material M1. In some constructions, the first outer layer 415, the inner layer 410, and the second outer layer 420 can be provided in a 10/80/10 ratio. In other constructions, the second material M2 can comprise greater than 80% of the material of the material strip 405.

FIGS. 9A and 9B illustrate another embodiment of a material strip 505 from which the compound fuses 190, 290 can be formed. The material strip 505 is a clad metal material strip 505 provided as an edgelay including the second material M2 (e.g., an aluminum-based material) bonded to the first material M1 (e.g., copper-based material) along each respective edge. The first and second materials M1, M2 define interlocking fingers 510a, 510b that engage each other to improve the integrity of the bond.

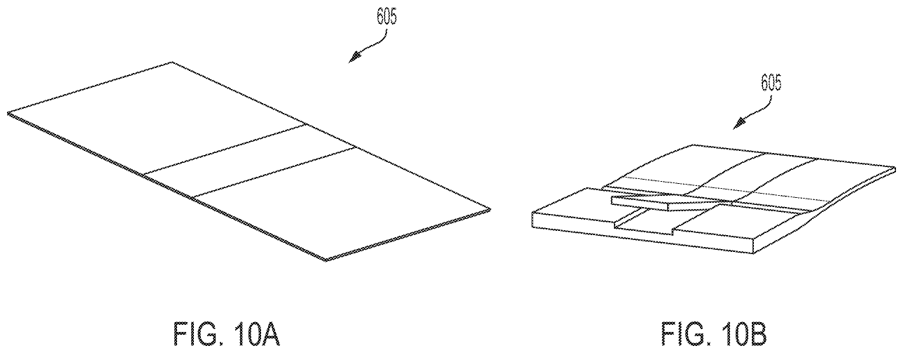

FIGS. 10A and 10B illustrate another embodiment of a material strip 605 from which the compound fuses 190, 290 can be formed. The material strip 605 is a clad metal material strip 605 provided as an inlay including the second material M2 (e.g., an aluminum-based material) inlaid into a groove formed in first material M1 (e.g., copper-based material).

Although the disclosure has been described in detail with reference to certain preferred embodiments, variations and modifications exist within the scope and spirit of one or more independent aspects of the disclosure as described.

What is claimed is:

1. A battery pack comprising:
a battery pack housing;
a plurality of battery pack terminals;
a plurality of battery cells supported within the battery pack housing and electrically connected to one another, at least one battery cell including a battery cell terminal; and
a compound fuse electrically coupled between the battery cell terminal of the at least one battery cell and at least one battery pack terminal, the compound fuse comprising a first material and a second material that has a lower melting point than the first material, the compound fuse including
a first portion electrically coupled to the battery cell terminal,
a second portion electrically coupled to the at least one battery pack terminal, and
a fuse portion that connects the first portion to the second portion, the fuse portion being configured to establish a discontinuity between the first portion and the second portion during a hard short event.

2. The battery pack of claim 1, wherein the second material is clad in the first material on each of a first side of the compound fuse and a second side of the compound fuse, the second side being located opposite the first side.

3. The battery pack of claim 1, wherein the second material is inlaid into the first material.

4. The battery pack of claim 1, wherein the fuse portion is attached to the first portion and to the second portion by ultrasonic welding.

5. The battery pack of claim 1, wherein the first portion is at least partially formed from the first material and the fuse portion is at least partially formed from the second material.

6. The battery pack of claim 1, wherein each of the first portion, the second portion, and the fuse portion are at least partially formed from the second material.

7. The battery pack of claim 6, wherein the first portion and the second portion are partially formed from the first material.

8. The battery pack of claim 1, wherein the first material is coupled to the second material by at least one of electroplating and plasma coating.

9. The battery pack of claim 1, wherein the compound fuse further includes a first elongated slot that partially separates the first portion from the second portion, and a second elongated slot communicating with the first elongated slot and extending perpendicular thereto, the second elongated slot defining a longitudinal length of the fuse portion.

10. The battery pack of claim 1, wherein a current flow path is defined along the fuse portion between the first portion and the second portion, and wherein the fuse portion defines a minimum cross-sectional area of the compound fuse along the current flow path.

11. A battery pack comprising:
a battery pack housing;
a negative battery pack terminal and a positive battery pack terminal;
a plurality of battery cells supported within the battery pack housing and electrically connected to one another, to the negative battery pack terminal, and to the positive battery pack terminal, at least one battery cell including a battery cell terminal;
a compound fuse electrically coupled between the battery cell terminal and the negative battery pack terminal, the compound fuse comprising a first material and a second material that has a lower melting point than the first material, the compound fuse including
a first portion electrically coupled to the battery cell terminal,
a second portion electrically coupled to at least one of the negative battery pack terminal and the positive battery pack terminal, and
a fuse portion that connects the first portion to the second portion, the fuse portion being configured to establish a discontinuity between the first portion and the second portion during a hard short event, the fuse portion being formed from the second material.

12. The battery pack of claim 11, wherein the first portion and the second portion are each formed from each of the first material and the second material.

13. The battery pack of claim 11, wherein the first portion and the second portion are formed from only the first material.

14. The battery pack of claim 11, wherein the fuse portion is attached to the first portion and to the second portion by ultrasonic welding.

15. The battery pack of claim 11, wherein the first material is coupled to the second material by at least one of electroplating and plasma coating.

16. The battery pack of claim 11, wherein the compound fuse further includes a first elongated slot that partially separates the first portion from the second portion, and a second elongated slot communicating with the first elongated slot and extending perpendicular thereto, the second elongated slot defining a longitudinal length of the fuse portion.

17. The battery pack of claim 11, wherein a current flow path is defined along the fuse portion between the first portion and the second portion, and wherein the fuse portion defines a minimum cross-sectional area of the compound fuse along the current flow path.

18. The battery pack of claim 11, wherein the second material is clad in the first material on each of a first side of the first portion and a second side of the first portion, the second side being located opposite the first side.

19. The battery pack of claim 11, wherein a first lateral slot is defined in a first lateral side of the compound fuse and a second lateral slot is defined in a second lateral side of the compound fuse, the second lateral side being located opposite the first lateral side, and wherein the fuse portion is located between the first lateral slot and the second lateral slot.

20. A compound fuse for a battery pack, the compound fuse configured to be coupled between a battery cell terminal of the battery pack and a battery pack terminal of the battery pack, the compound fuse comprising:
a first portion located at a first end of the compound fuse;
a second portion located at a second end of the compound fuse; and
a fuse portion that connects the first portion to the second portion, the fuse portion being configured to establish a discontinuity between the first portion and the second portion during a hard short event;
wherein each of the first portion, the second portion, and the fuse portion are at least partially formed of a first material; and
wherein the first portion and the second portion are also partially formed of a second material that has a lower melting point than the first material.
